(19) United States
(12) Patent Application Publication
(10) Pub. No.: US 2009/0202855 A1
(43) Pub. Date: Aug. 13, 2009

(54) POROUS SLIDING BEARING AND METHOD OF CONSTRUCTION THEREOF

(76) Inventors: David M. Saxton, Ann Arbor, MI (US); Eric Konieczny, Royal Oak, MI (US); Robert Sturk, Plymouth, MI (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/350,364

(22) Filed: Jan. 8, 2009

Related U.S. Application Data
(60) Provisional application No. 61/020,058, filed on Jan. 9, 2008.

(51) Int. Cl. B32B 15/00; B22F 7/04; B22F 3/12; B32B 5/18

(52) U.S. Cl. 428/546; 419/8; 419/2; 428/613

(57) ABSTRACT

A bearing material including a Cu—Sn—Bi alloy layer and method of construction thereof is provided. The alloy layer has a porosity ranging from about 2% to about 10%. A majority of the porosity has pores separate and out of direct communication with one another such that the pores are not interconnected with one another. The alloy layer can be sintered to a metal backing layer, and can be shaped as desired for an intended bearing application.

### CROSS-REFERENCE TO RELATED APPLICATION

This application claims the benefit of U.S. Provisional Application Ser. No. 61/020,058, filed Jan. 9, 2008, which is incorporated herein by reference in its entirety.

### BACKGROUND OF THE INVENTION

1. Technical Field

This invention relates generally to sliding bearing materials, and more particularly to sliding bearing materials having an alloy fixed to a metal backing and methods of construction thereof.

2. Related Art

Prior sliding bearings and bushings are known to fall into two basic categories: those that are essentially fully dense products in which a relatively softer bearing metal is secured to a rigid backing of steel; and those which are made of sintered bronze powder alloys and are highly porous with an open, highly interconnected pore structure for absorbing oil or impregnating other materials, such as PTFE.

It is not always desirable to have a high porosity bearing with highly interconnected pores, as such bearings can in some circumstances be too absorptive. The open interconnected porous structure is achieved by carefully controlling the size of the bronze particles, with the particles ideally being all the same size, so as to maximize the interstitial connected space between sintered particles. Using monosize bronze particles is costly, since only a relatively small percentage of particles produced in a batch would be of essentially the same size. It will be appreciated that the inclusion of smaller particles in such a mix would cause them to migrate to the open interstices and thus reduce the level of interconnected porosity.

Also known are essentially lead-free sintered powder metal bearing materials, including bronze alloy bearings containing a certain amount of bismuth in lieu of lead. Such a material is known from U.S. Pat. No. 6,746,154. These bearings can be produced by spreading prealloyed CuSnBi powder on a steel backing, roll compacting the material, sintering the compacted material followed by a secondary rolling and sintering operation to yield an essentially porous-free material (i.e., with a porosity less than 1%). These materials are not made of monosize particles in order to maximize the densification of the material.

### SUMMARY OF THE INVENTION

A sliding bearing (or bushing) comprises a Cu—Sn—Bi alloy having a porosity ranging from 2% to about 10%. At least the majority of the porosity is not interconnected. In other words, while the material exhibits a relatively high degree of porosity for a Cu—Sn—Bi alloy, the porosity is not interconnected in the sense of a traditional bronze bushing, but rather is isolated such that the pores act as pockets, but not channels leading to a network of open pores.

### BRIEF DESCRIPTION OF THE DRAWINGS

These and other aspects, features and advantages of the invention will become readily apparent to those skilled in the art in view of the following detailed description of the presently preferred embodiments and best mode, appended claims, and accompanying drawings, in which:

FIG. 1 is a schematic partial cross-sectional side view of a bearing material constructed in accordance with one aspect of the invention; and

FIG. 2 illustrates schematically a process in accordance with another aspect of the invention for constructing the bearing material of FIG. 1.

### DETAILED DESCRIPTION OF PRESENTLY PREFERRED EMBODIMENTS

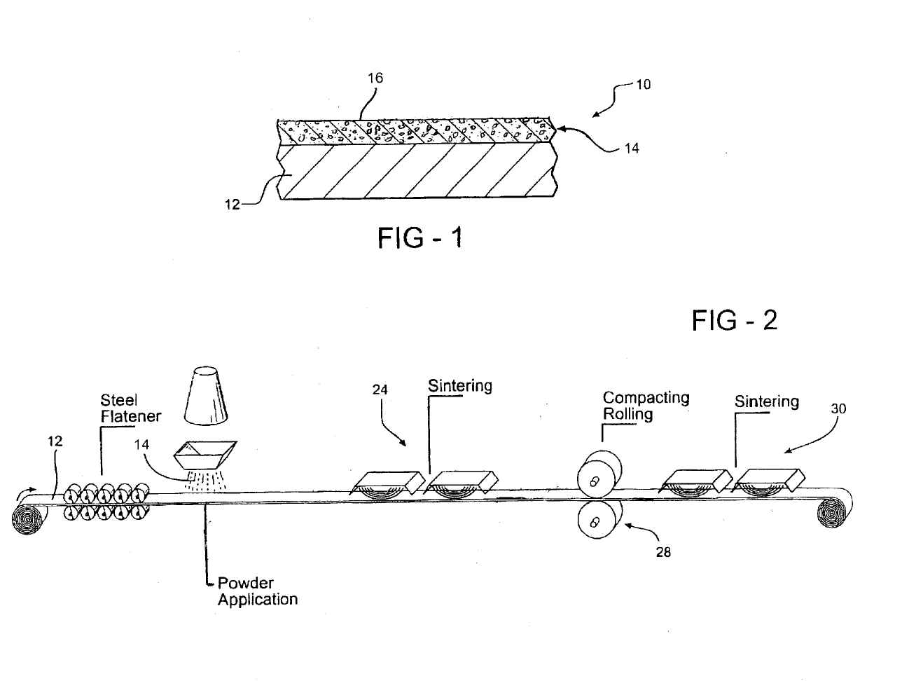

Referring in more details to the drawings, FIG. 1 illustrates a sliding bearing material, referred to hereafter as bearing 10, constructed according to one presently preferred aspect of the invention. The bearing 10 includes a metal backing layer 12 which may be of steel and a sliding alloy powder layer 14 of the Cu—Sn—Bi alloy material. In accordance with the invention, the sliding layer 14 has a substantially non-interconnected porosity 16. Accordingly, the vast majority of the pores 16 within the sliding alloy layer 14 remain spaced from one another such that they are separate and out of communication with one another, thereby avoiding being too absorptive.

The method for making such a controlled, unconnected porosity alloyed powered bearing layer 14 according with the invention is illustrated schematically in FIG. 2. Unlike prior methods of constructing alloyed bearing layers, the present inventive method resides not in selecting monosize particles, which is known to be costly, as traditional with sintered bronze oil impregnated bearings as described above in the background, but rather in the way the alloyed sliding bearing material layer 14 is processed. In particular, the Cu—Sn—Bi powder is selected preferably as prealloyed powder, wherein the individual size of the grains of the power mix can vary, thereby being economical in production. The powdered layer 14 is spread on a steel backing strip layer 12 and sintered at a sintering station 24 in a primary sintering stage. Accordingly, the sintering step is performed without first compacting the powdered layer 14, thus, eliminating a step as described in the background, and lending to a lower relative compaction and hardness of the material at this stage in comparison with known method of constructing sliding bearing alloyed material layers. Following the primary sintering stage and while still hot, the material is rolled at a compacting station 28 under a reduced load in comparison to the fully dense Cu—Sn—Bi bearings, as describe above in the background, thereby further lending to a lower relative compaction and hardness of the sintered material at this stage. The material is then sintered again at a sintering station 30 in a secondary sintering stage. Upon completing the secondary sintering step, the bearing material 10 is ready for use without further compaction.

Surprisingly, applicants found that a standard mix of particle sizes of prealloyed Cu—Sn—Bi powder could be used to make a relatively high porosity Cu—Sn—Bi bearing layer having a low percentage of interconnected pores by adjusting the rolling process and eliminating a sintering step, i.e. post secondary sintering. The alloy bearing material layer 14 has the desirable property of about 2% up to about 10% porosity of the total layer volume, but the majority, greater than 50%, of the porosity is not interconnected. The alloy bearing material layer 14 holds oil within the individual pores 16, which are maintained out of direct communication with one another, such as by not being interconnected by channels, but does not absorb it in the sense of a traditional sintered bronze bearings with interconnected porosity.

It has further been found that the compaction and resultant non-interconnected porous structure 16 can be influenced by the speed of rolling, with a lower line speed favoring the development of the desired high porosity, but low interconnectivity of the pores.

Such bearing materials can be applied to steel backings and serve as a bearing material for sliding bearings or for bushings in oil containing environments.

The presence of the bismuth has the beneficial effect of providing additional lubrication in the event of oil starved running conditions, to supplement what little oil there may be available to the bearing.

Obviously, many modifications and variations of the present invention are possible in light of the above teachings. It is, therefore, to be understood that within the scope of the appended claims, the invention may be practiced otherwise than as specifically described.

What is claimed is:

1. A bearing material, comprising:
a Cu—Sn—Bi alloy layer having a porosity ranging from about 2% to about 10%, a majority of said porosity having pores separate and out of direct communication with one another such that said pores are not interconnected with one another.

2. The bearing material of claim 1 further comprising a metal backing layer attached to said alloy layer.

3. The bearing material of claim 1 wherein the alloy comprises individual grains of varying size.

4. The bearing material of claim 1 wherein said alloy layer is sintered.

5. A method of constructing a bearing material, comprising:
providing a metal backing layer;
spreading an alloyed powder material layer of Cu—Sn—Bi on the backing layer;
sintering the powder material layer in a primary sintering step;
compacting the sintered power material layer; and
sintering the compacted material layer in a secondary sintering step.

6. The method of claim 5 wherein the primary sintering step is performed without previously compacting the powder material layer.

7. The method of claim 5 further including providing the alloyed powder material layer of Cu—Sn—Bi with a porosity ranging from about 2% to about 10% upon completing the secondary sintering step.

8. The method of claim 7 further including providing a majority of the porosity with pores separate and out of direct communication with one another such that the pores are not interconnected with one another upon completing the secondary sintering step.

9. The method of claim 5 wherein the secondary sintering step is the final process step for the alloyed powder material layer.

10. A method of constructing a bearing material, comprising:
sintering an alloyed powder material layer of Cu—Sn—Bi in a primary sintering step;
compacting the sintered power material layer; and
sintering the compacted material layer in a secondary sintering step whereupon the resulting sintered material layer has a porosity ranging from about 2% to about 10% with a majority of the porosity having pores that are not interconnected with one another.

11. The method of claim 10 further including providing a metal backing layer and spreading the alloyed powder material on the backing layer prior to the primary sintering step.

12. The method of claim 10 wherein the secondary sintering step completes the processing of the alloyed powder material.

13. The method of claim 10 wherein the primary sintering step is performed without previously compacting the powder material layer.

14. The method of claim 10 further including providing the alloyed powder material layer having varying grain sizes.
